(19) United States
(12) Patent Application Publication
(10) Pub. No.: US 2005/0076742 A1
(43) Pub. Date: Apr. 14, 2005

(54) Opener for producing hole in side of pressurized beverage can

(76) Inventors: John Terry Yurek JR., Valencia, CA (US); David Robert Millar, Alido Viejo, CA (US)

Correspondence Address: John Terry Yurek Jr., 26504 BRYCE Road, Valencia, CA, 91254, US

(21) Appl. No.: 10/961,276

(22) Filed: Oct. 8, 2004

Related U.S. Application Data
(60) Provisional application No. 60/509,547, filed on Oct. 9, 2003.

(51) Int. Cl. B67B 7/16

(52) U.S. Cl. 81/3.55

(57) ABSTRACT

An opener has a slightly rounded tip that is used to pierce a sidewall of a cylindrical container. The opener also has a hook that extends into a recess formed in a bottom surface of the container. The hook has a surface serves as a fulcrum for the opener to assist in formation of the opening in the sidewall of the container.

### RELATED APPLICATIONS

This application hereby claims the priority benefit under 35 U.S.C. § 119(e) of U.S. Provisional Patent Application No. 60/509,547, filed on Oct. 9, 2003, which is hereby incorporated by reference in its entirety.

### BACKGROUND OF THE INVENTION

1. Field of the Invention

The present invention generally relates to can openers. More particularly, the present invention relates to can openers that are configured to pierce a side wall of a pressurized beverage can.

2. Description of the Related Art

Beer is often consumed at parties. One manner in which the beer is consumed has been commonly called “shot gunning” the beer. To “shot gun” beer, an opening is formed in the lower sidewall of the can while the can is generally inverted. Once the opening is formed in the lower sidewall of the can, the can is raised with the hole placed to the mouth of the consumer and with the top of the can positioned higher than the hole. The pull tab on the top of the can is then pulled and the contents of the can rapidly flow through the hole in the side of the can.

In the past, the consumer had to form the hole in the side of the can by stabbing the side of the can with a knife, keys or the like. Needless to say, such a technique creates a very great risk of bodily injury during the formation of the opening. Moreover, holes formed in such a manner tended to be uneven with sharp edges jutting outward from the can. Thus, there is room for improvement in hole forming technology useful to those wanting to consume beer or other beverages by the shot gun technique.

### SUMMARY OF THE INVENTION

Accordingly, one aspect of the present invention involves an opener comprising a piercing tip. The piercing tip comprises a generally triangular body with a generally rounded apex. The generally rounded apex is bent slightly downward. The generally triangular body comprises a base positioned generally opposite to the generally rounded apex. The base defines a first width. A handle is connected to the base. A hook depends downward from one of the handle and the base at a location proximate the connection of the base to the handle. The hook comprises a forward extending lip. At least a portion of the hook has a width substantially equal to the first width. A recess is defined between the piercing tip and the hook. A vertical distance between the base and the lip is greater than a vertical distance between the apex and the lip.

Another aspect of the present invention involves a method of using an opener designed to form an opening in a cylindrical sidewall of a beverage container. The opener has a hook positioned between a rounded piercing tip and a handle. The method comprises placing the hook within a recess defined within a lower surface of the container, forcing the rounded piercing tip into the cylindrical sidewall of the beverage container adjacent to the lower surface of the container and lifting the handle to form a generally triangular opening in the cylindrical sidewall.

### BRIEF DESCRIPTION OF THE DRAWINGS

These and other features, aspects and advantages of the present invention will now be described with reference to the drawings of several preferred embodiments, which embodiments are intended to illustrate and not to limit the invention. The drawings comprise 25 figures.

FIGS. 1 and 2 are perspective and side views respectively of an opener arranged and configured in accordance with certain features, aspects and advantages of the present invention. The opener is shown positioned on a container and ready to form a lower opening in the container.

FIGS. 3 and 4 are perspective and side views of the opener of FIGS. 1 and 2 with the opener shown positioned on the container and the opener having formed the lower opening in the container.

FIGS. 5 and 6 are perspective views of the opener of FIGS. 1 and 2.

FIGS. 7-9 are three additional views of the opener of FIGS. 1 and 2.

FIGS. 10 and 11 are perspective views of another opener arranged and configured in accordance with certain features, aspects and advantages of the present invention. The illustrated opener also comprises a pull-tab opener, a bottle opener and a key ring.

FIGS. 12-14 are three additional views of the opener of FIGS. 10 and 11.

FIGS. 15-17 are perspective views of a further opener arranged and configured in accordance with certain features, aspects and advantages of the present invention. The illustrated opener comprises an integrated whistle and a pull-tab opener.

FIGS. 18-20 are three additional views of the opener of FIGS. 15-17.

FIGS. 21 and 22 are perspective views of yet another opener arranged and configured in accordance with certain features, aspects and advantages of the present invention. The illustrated opener comprises an integrated light, a pull tab opener and a bottle opener.

FIGS. 23-25 are three additional views of the opener of FIGS. 21 and 22.

### DETAILED DESCRIPTION OF THE PREFERRED EMBODIMENT

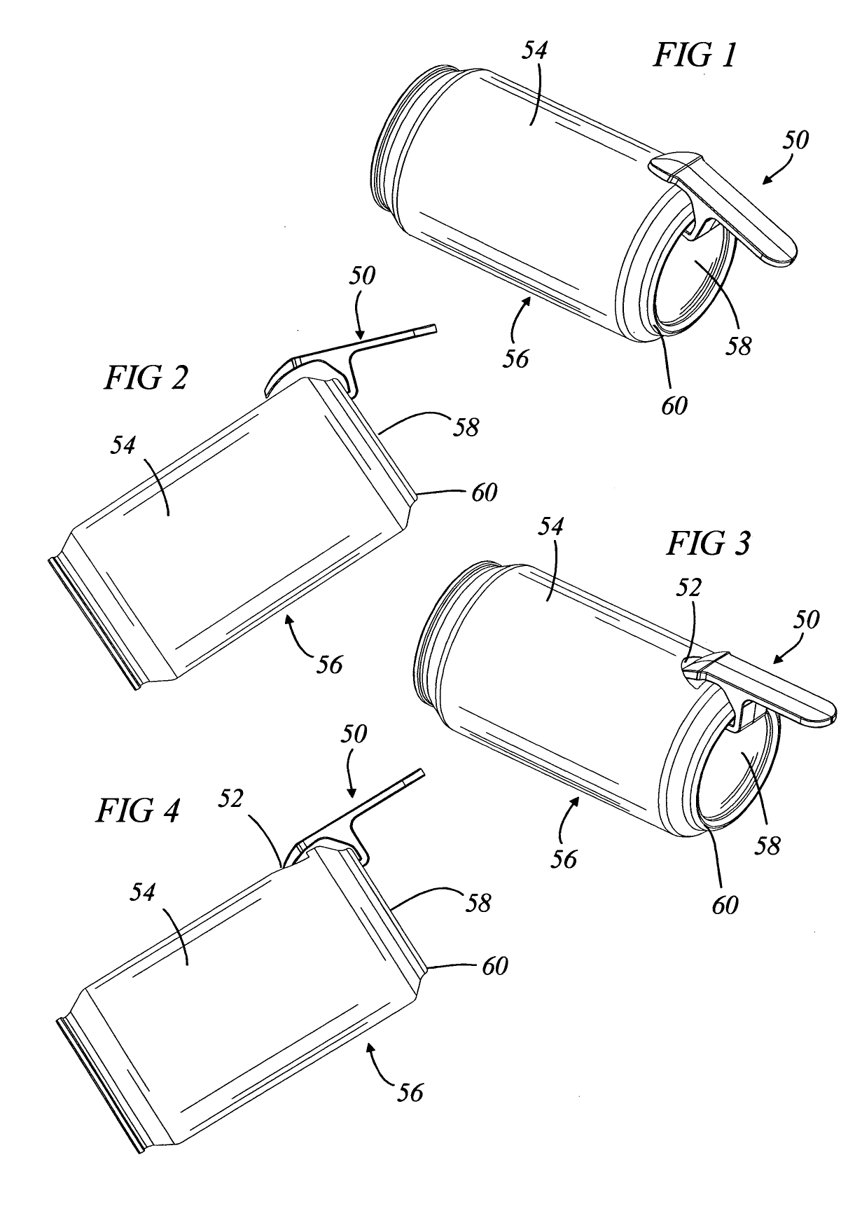

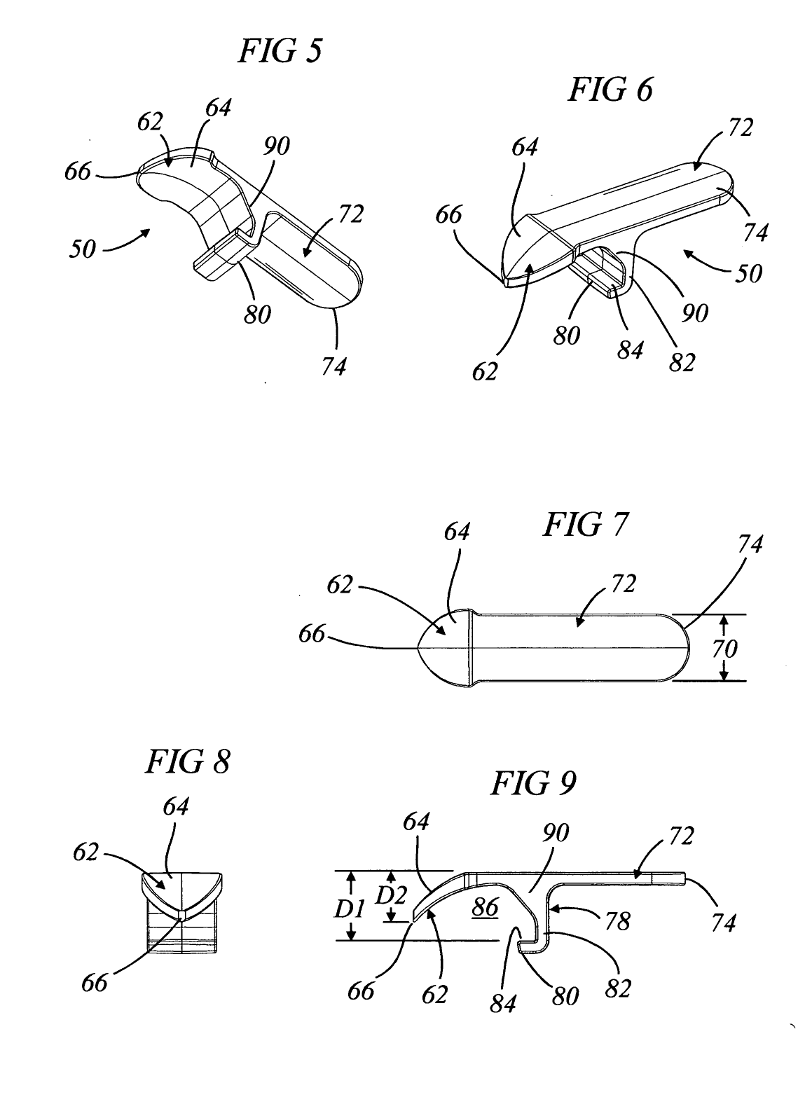

With reference now to FIGS. 1-9, an opener 50 is illustrated. The illustrated opener 50 is specifically adapted for use in forming an opening 52 in a side wall 54 of a beverage container 56. The bottom of the container 56 generally comprises a recess 58 defined in part by a rim 60. The opener 50 preferably is designed and configured to be oriented relative to the rim 60. The opener 50 can be formed of any material but preferably is formed of injection molded plastic. In some configurations, the opener 50 can be formed of metal or other materials in any suitable manner.

With reference to FIG. 1, the opener 50 generally comprises a piercing tip 62. The piercing tip 62 advantageously is designed to form the opening 52 in the side wall 54 of the beverage container. In the illustrated arrangement, the tip 62 comprises a generally triangular body 64. The body 64, in turn, comprises an apex 66 and a base 68 that is generally diametrically opposed to the apex 66. The body 64 preferably curves downward. As used herein, downward means the direction of the container 56 when the opener 50 is positioned on the container 56 to form the opening 52 in the side wall 54 and upward will mean the opposite direction. The generally triangular configuration of the body 64 allows the small apex 66 to initially form the opening 52 with less force than a larger structure would require. The sides of the triangular configuration expand the opening 52 to produce an advantageously large opening 52 through which the beverage can easily flow. Moreover, the hole 52 features an edge that is rolled rearward rather than a ragged perimeter. Furthermore, the body 64 preferably is large enough to accommodate a thumb of a user, such that the user can depress the apex 66 into the sidewall 54 of the container 56 with the thumb or another finger.

In the illustrated arrangement, the tip 62 is slightly rounded. Thus, the tip 62 advantageously does not form a sharp cutting point. Such a construction is advantageous in that the opener 50 commonly may be carried in a pocket. As such, a sharp end, if exposed, might result in minor damage to the pocket or possible scratching of a hand when the hand retrieves the opener 50 from the pocket. Thus, by comprising a rounded surface on the tip 62, the opener 50 is capable of being carried in a pocket without the same concerns that would be associated with an opener having a sharp end. Moreover, because the opener 50 is used to pierce relatively thin-walled containers, a sharp point is not necessarily needed. If a sharp point were provided, a cap or the like would be preferred.

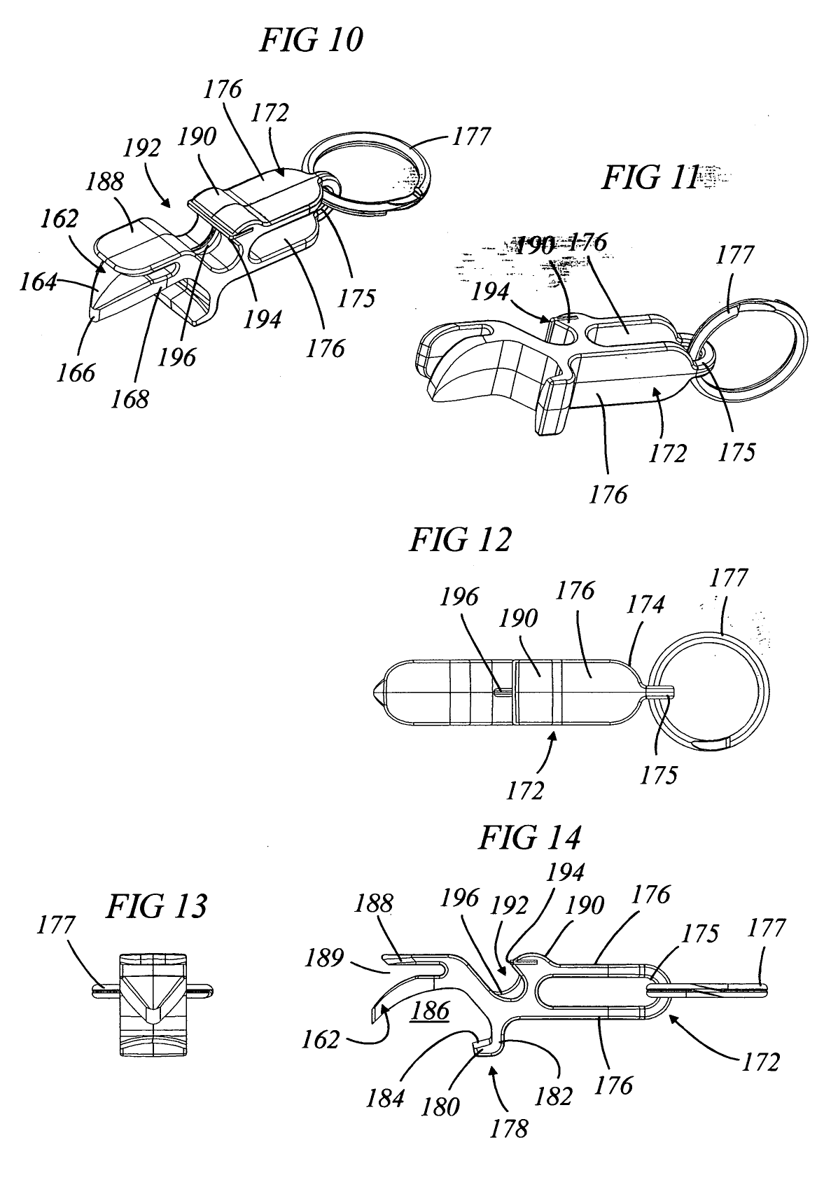

As introduced above, the body 64 also comprises the base 68. The base 68 defines a first width 70 (see FIG. 7) where the body 64 connects to a handle 72. In some arrangements (see FIGS. 1-9), the base 64 is somewhat smaller than the overall width of the tip 62 and, in other arrangements (see FIGS. 10-14 and 21-25), the base 64 and the overall width of the tip 62 have substantially the same width.

With reference to FIGS. 7 and 9, the handle 72 extends generally rearward from the tip 62. As used herein, rearward will mean away from the tip 62 while forward will mean toward the tip 62. In one arrangement, the handle 72 is generally linear and planar. Other configurations can be used and some of those configurations will be discussed below. Preferably, the rear end 74 of the handle 72 is rounded. Again, the rounded end 74 advantageously reduces the presence of square edges in contemplation of the opener 50 being carried in a pocket.

With continued reference to FIG. 9, a hook 78 extends downward from at least one of the handle 72 and the tip 62. In most arrangements, the hook 78 is positioned between the tip 62 and the handle 72. In the arrangement illustrated in FIG. 9, the hook 78 extends downward from the handle 72. Advantageously, the hook 78 is positioned at the forward end of the handle 72 to provide sufficient leverage at the tip 62 when the hook 78 is properly positioned on the rim 60.

The hook 78 comprises a forwardly extending lip 80. The lip 80 extends forward from a lower end of a shank 82 of the hook 78. The lip 80 preferably has a width that is generally the same as the first width 70. In one advantageous arrangement, the shank 82 and the lip 80 preferably have widths that are generally the same as the first width 70. By having an enlarged width, the hook 78 can gain a better connection to the container 56 and allow more force to be transferred to the tip 62 when the handle 72 is raised.

With reference to FIG. 9, the lip 80 comprises an upper surface 84. The upper surface 84 generally is the surface that engages the rim 60 or another surface within the recess 58 of the container 56. In some arrangements, the upper surface 84 can be curved to generally the same radius of the rim 60 of the container 56.

As illustrated, the upper surface 84 preferably is spaced further away from the handle 72 than the apex 66. Stated another way, a distance D1 from the upper surface 84 to a datum line (such as the handle in the illustrated arrangement) is greater than a distance D2 to the apex 66 from the same datum line. This distance D1 desirably is set to be great enough to allow the upper surface 84 to engage the container 56 prior to the apex 66 engaging the side wall 54 of the container 56. Thus, a recess 86 is defined between the tip 62 and the hook 78 and a portion of the container 56 is received within the recess 86.

With continued reference to FIG. 9, in the illustrated embodiment, a reinforcing gusset 90 is defined between the handle 72 and the hook 78. The illustrated gusset 90 extends at an angle and relative to the handle 72 and the shank 82 and preferably is positioned on the tip-side of the shank 82. The illustrated gusset 90 also extends the width of the shank 82 in the illustrated arrangement. Gussets having different widths also can be used. In one configuration, multiple spaced walls can be used to form the gusset 90. In some arrangements, the gusset 90 can be positioned on the rear side of the shank 82. In one configuration, the gusset 90 is not formed by a straight wall but is formed by a curved wall. In one less desired configuration, the gusset 90 is omitted.

With reference now to FIGS. 10-14, another opener 150 is shown that is arranged and configured in accordance with certain features, aspects and advantages of the present invention. To simplify the description, components will not be re-described in detail if they were described above. Rather, the components in the embodiment of FIGS. 10-14 will be given a reference numeral that retains the same last two digits as the reference numeral used in the embodiment of FIGS. 1-9 and the last two digits will be preceded with a numeral 1. Thus, the opener 150 generally corresponds to the opener 50 with certain differences that will be illuminated in the following discussion.

As illustrated, the opener 150 comprises a piercing tip 162 with a body 164, a rounded apex 166 and a base 168. These components are arranged generally in the same manner as the corresponding components of the opener 50 illustrated in FIGS. 1-9.

The opener 150 comprises a handle 172. The handle 172 in the illustrated arrangement comprises a pair of spaced prongs 176. Each of the spaced prongs 176 comprises a generally rounded rear end 174. The rear end 174 of each of the prongs 176 advantageously are joined by an extension 175. The extension 175 can be integrally formed within the prongs 176 or can be formed separately there from and attached in any suitable manner. As illustrated, side surfaces of the prongs 176 can be used to carry messages or other indicia if desired.

The extension 175, in combination with the prongs 176, defines an enclosure in which a key ring 177 can be positioned. Thus, the opener 150 also comprises a key ring 177 in the arrangement illustrated in FIGS. 10-14.

With reference to FIG. 14, the opener 150 further comprises a hook 178 that extends downward from the handle 172. The hook 178 comprises a forwardly extending lip 180 and a shank 182. The lip 180 comprises an upper surface 184 and a recess 186 is defined by the hook 178 and the tip 162.

A short projection 188 extends above at least a portion of the tip 162. Together with the tip, the projection 188 defines a second recess 189. The projection preferably has a width that is generally consistent with a width of the prongs 176 of the handle 172. In some arrangements, the projection may slightly taper in the forward direction. Moreover, as shown, in one preferred arrangement, the forward end of the projection 188 is slightly sloped such that the top of the projection extends slightly forward of the bottom of the projection. Such an arrangement is advantageous because the projection 188 is designed to slide under a pull tab with the pull tab fitting into the second recess 189 to assist opening a beverage can for normal drinking from the can or for releasing the vacuum formed in the container prior to shot gunning the beverage. Other shapes and configurations also can be used keeping in mind the desire to use the projection 188 to open pull-tab cans.

FIG. 14 also illustrates a ledge 190 that is positioned rearward of the projection 188. The ledge 190 in the illustrated arrangement is connected to the handle 172. Forward of the projection 188 is a third recess 192. Thus, together with a portion of the tip 162, a portion of the projection 188 and the ledge 190 define the third recess 192. Stated another way, in the illustrated arrangement, the ledge 190 is positioned between the piercing tip 162 and the handle 172.

The ledge 190 preferably comprises a tooth or insert 194 formed of metal or another hardened material. The insert 194 can be inserted or formed during manufacturing. In arrangements in which the opener 150 is formed of a hardened material, such as a metal for example, the insert 194 can be omitted. Advantageously, the insert 194 forms a stiff surface. The third recess 192 accommodates a bottle cap and the insert 194 aids the opener 150 in removal of the bottle cap from a corresponding bottle. Other configurations also can be used keeping in mind the goal of removing the cap from a bottle. For instance, the insert 194 can be rearwardly facing and the third recess 192 can be located in a reverse orientation although such a construction may reduce the amount of leverage able to be generated at the insert 194 or the ledge 190.

With continued reference to FIG. 14, at least one rib 196 preferably is positioned in the third recess 192. The rib 196 provides some reinforcement and also helps orient the bottle cap within the recess 192. While a single rib is illustrated, more than one rib can be used if desired. Moreover, the rib 196 extends in a direction generally normal to the ledge 190.

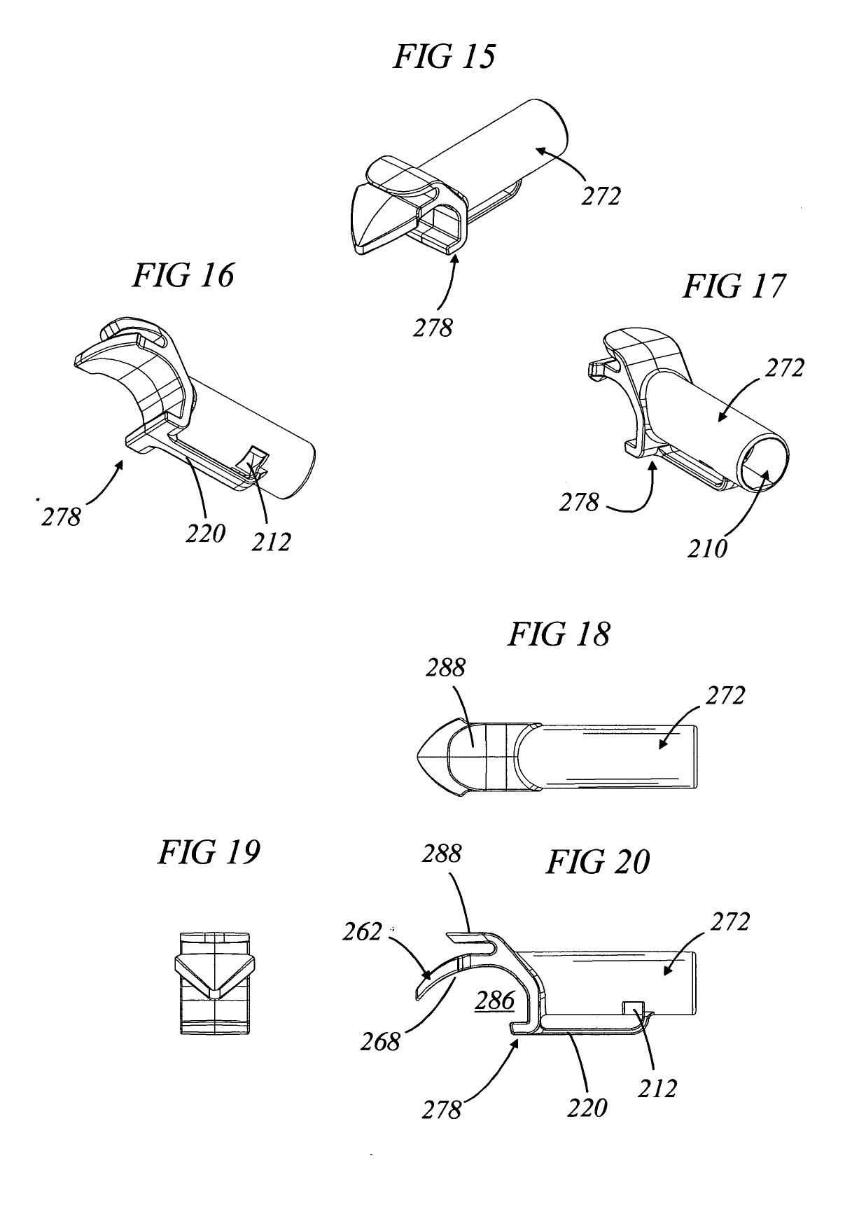

With reference now to FIGS. 15-20, an additional embodiment of an opener 250 is illustrated that is arranged and configured in accordance with certain features, aspects and advantages of the present invention. Again, to simplify the description, components will not be re-described in detail if they were described above. Rather, the components in the embodiments of FIGS. 15-20 will be given a reference numeral that retains the same last two digits as the reference numeral used in the embodiments of FIGS. 1-14 and the last two digits will be preceded with a numeral 2. Thus, the opener 250 generally corresponds to the opener 50 and the opener 150 with certain differences that will be illuminated in the following discussion.

The handle 272 in the illustrated arrangement is generally cylindrical. More preferably, the handle 272 extends rearwardly of a hook 278 and comprises a cylindrical tube that defines a lumen 210. At its forward end, the lumen 210 communicates with at least one bottom passage 212 and, more preferably, a pair of bottom passages 212. The bottom passages 212 are shaped such that the handle 272 defines a whistle. Different configurations can be used if they are consistent with the desire to form a whistle in the illustrated arrangement. For instance, while the illustrated arrangement features a so-called pealess whistle, arrangements with a pea chamber can be used. Moreover, the outer shape of the handle 272 can be square, elliptical or any other desired shape, and the bottom passages 212 may be on the sides or top of lumen 210.

In comparing FIG. 20 to FIG. 14, the projection 288 is shortened compared to the projection 188 of the opener 150. As illustrated, the projection 288 extends slightly forward of the base 268 of the tip 262. Such a configuration results in a strengthened projection 288 because the length of the projection 288 is reduced. However, such a configuration increases the likelihood that the projection 288 may slip from a can tab prior to the can being opened.

With continued reference to FIG. 14, an attachment ring 220 can be positioned rearward of the hook 278. Other positions also can be used but by positioning the ring 220 within a corner defined by the hook 278 and the handle 272, the ring 220 is supported over more than one quarter of its circumference. Such a placement, therefore, enhances the strength of the ring 200. Other positions also can be used that remove any key rings or the like from the region proximate the hook 278. For instance, placing the ring 220 on the handle 272 rearward of the passages 212 and on the topside can provide a more balanced construction and remove any key ring that might be attached to the ring 220 from the presence of the hook 278 and the recess 286.

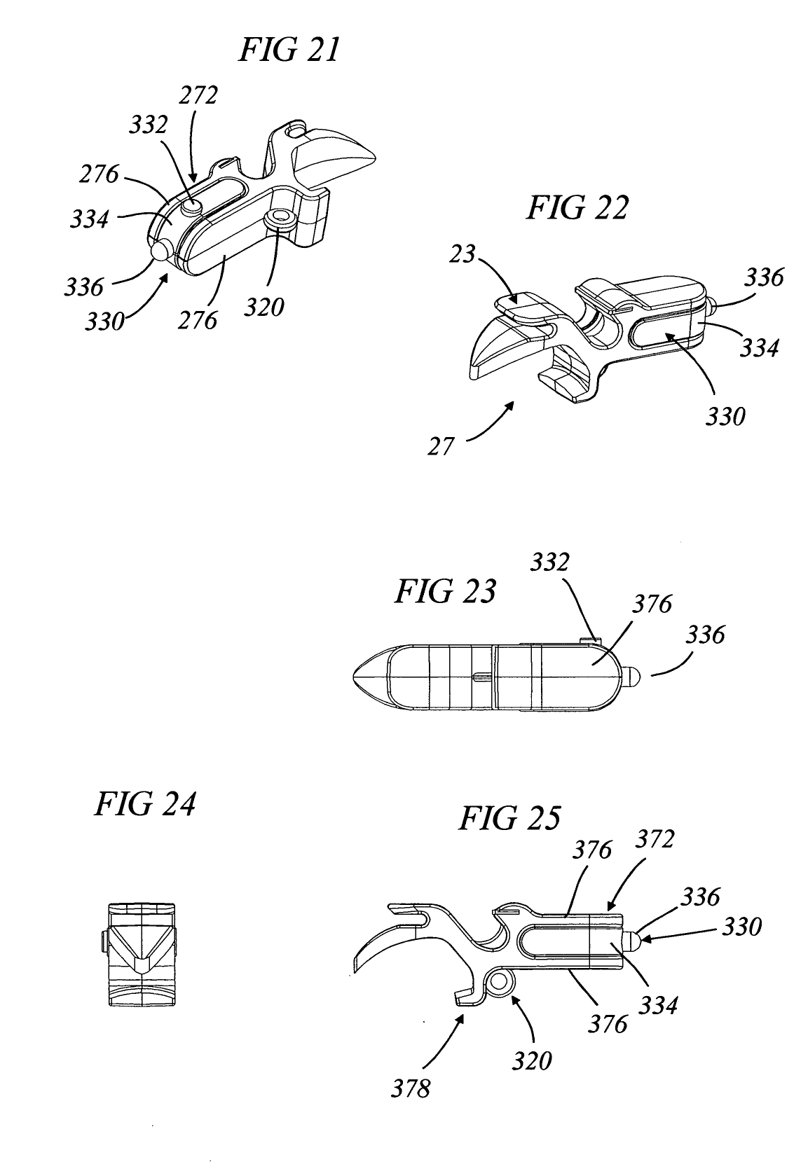

With reference now to FIGS. 21-25, a further embodiment of an opener 350 is illustrated that is arranged and configured in accordance with certain features, aspects and advantages of the present invention. Once again, to simplify the description, components will not be re-described in detail if they were described above. Rather, the components in the embodiments of FIGS. 21-25 will be given a reference numeral that retains the same last two digits as the reference numeral used in the embodiments of FIGS. 1-20 and the last two digits will be preceded with a numeral 3. Thus, the opener 350 generally corresponds to the opener 50, the opener 150 and the opener 250 with certain differences that will be illuminated in the following discussion.

As illustrated, the opener 350 comprises an attachment ring 320. As discussed above, the ring 320 can be positioned in other suitable locations. The ring 320, however, is well supported in the crook defined between the handle 372 and the hook 378.

While the illustrated opener 350 is similar to the opener 150 shown in FIGS. 10-14, a light 330 is positioned within the enclosure defined between the prongs 376 and no extension is provided to define the rearward end of the enclosure. The light 330 preferably fills the region defined between the prongs 376. The light can be constructed in any suitable manner. In the illustrated arrangement, a switch 332 is provided that is moveable relative to an enclosure 334. A battery or other power source is contained within the enclosure 334. A light source 336, such as an LED or a low voltage light source, for instance but without limitation, extends from the enclosure 334 and is connected to the power source and the switch 332. Depressing the switch 332 activates the light source 336 and, in one arrangement, merely removing a finger from the switch 332 will deactivate the light source 336. Other suitable configurations also can be used keeping in mind the desire to have an easily used light source.

Prior to forming the opening 52 in the container, the container 56 is generally inverted to move an internal air pocket in the container 56 into the region in which the opening 52 will be formed. The inversion reduces the likelihood of spray from the opening 52 when initially formed. To form the opening 52 in the sidewall 54 of a container 56, the opener 50 is placed alongside the sidewall 54 of the container 56. The hook 78 is placed in the recess 58 with the upper surface 84 of the hook 78 resting on the rib 60. The apex 66 of the tip 62 is forced into the sidewall 54 with a thumb that is positioned in the region of the tip 62 (e.g., on the tip 62 or on the projection 188). Once the apex 66 initially penetrates the sidewall 54, the handle can be used to provide extra leverage to complete the formation of the opening 52. The handle 72 can be used at the same time as force is applied by a thumb to form the opening 52.

Although the present invention has been disclosed in the context of certain preferred embodiments, examples and variations, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub combinations of the specific features and aspects of any of the many embodiments may be made and still fall within the scope of the invention. It should be understood that various features and aspects of the disclosed embodiments can be combined with or substituted for one another in order to form varying modes of the disclosed invention. Moreover, some variations that have been described with respect to one embodiment and not another embodiment can be used with such other embodiments. Many variations have been described herein and cross application is intended where physically possible. Thus, it is intended that the scope of the present invention herein disclosed should not be limited by the particular disclosed embodiments described above, but should be determined only by a fair reading of the claims that follow.

1. An opener comprising a piercing tip, said piercing tip comprising a generally triangular body, said piercing tip being bent slightly downward, said generally triangular body comprising a base positioned generally opposite to said slightly rounded apex, a handle connected to said base, a hook depending downward from one of said handle and said base at a location proximate the connection of the base to the handle, said hook comprising a forward extending lip, a recess being defined between said piercing tip and said hook, and a vertical distance between said base and said lip being greater than a vertical distance between said apex and said lip.

2. The opener of claim 1 further comprising a gusset extending between a portion of said hook and a portion of said piercing tip.

3. The opener of claim 1 further comprising a short projection positioned vertically above said piercing tip such that a secondary recess is defined between said projection and said piercing tip with said piercing tip being positioned generally between said recess and said secondary recess.

4. The opener of claim 3, wherein at least a portion of said short projection has a width substantially equal to said base.

5. The opener of claim 1 further comprising a ledge that is connected to said handle, said ledge being positioned between a portion of said handle and said piercing tip, said ledge being positioned above a tertiary recess that at least partially defined among said ledge, said handle and said piercing tip with said piercing tip being positioned between said recess and said tertiary recess.

6. The opener of claim 5 further comprising a metal insert positioned within said ledge.

7. The opener of claim 5, wherein at least a portion of said ledge has a width substantially equal to said first width.

8. The opener of claim 5, further comprising a rib positioned within said secondary recess and extending in a direction generally normal to said ledge.

9. The opener of claim 1, wherein said handle comprises a generally cylindrical portion.

10. The opener of claim 9, wherein a lumen is defined within at least a portion of said generally cylindrical portion and at least one passage extends into said lumen to form a whistle that is integrated into said handle.

11. The opener of claim 10, wherein two passages extend into said lumen.

12. The opener of claim 1 further comprising a mounting ring connected to said opener at a location rearward of said recess.

13. The opener of claim 1, wherein an opening is defined through a width of said handle.

14. The opener of claim 13 further comprising a light source mounted within said opening.

15. The opener of claim 13 further comprising a key ring connected to said opener in said opening.

16. The opener of claim 1, wherein the material is either metallic or plastic.

17. The opener of claim 1, wherein said generally triangular body has a slightly rounded apex.

18. A method of using an opener designed to form an opening in a cylindrical side wall of a beverage container, the opener having a hook positioned between a piercing tip and a handle, the method comprising placing the hook within a recess defined within a lower surface of the container, forcing the piercing tip into the cylindrical side wall of the beverage container adjacent to the lower surface of the container and lifting the handle while pressing down onto the top of the piercing tip to form a generally geometric opening in the cylindrical sidewall.
